(19) United States
(12) Patent Application Publication
(10) Pub. No.: US 2015/0005157 A1
(43) Pub. Date: Jan. 1, 2015

(54) Optimization of Zero-PGM Catalyst Systems on Metallic Substrates

(71) Applicants: Zahra Nazarpoor, Camarillo, CA (US); Sen Kitazumi, Oxnard, CA (US); Johnny T. Ngo, Oxnard, CA (US)

(72) Inventors: Zahra Nazarpoor, Camarillo, CA (US); Sen Kitazumi, Oxnard, CA (US); Johnny T. Ngo, Oxnard, CA (US)

(73) Assignee: CDTi, Ventura, CA (US)

(21) Appl. No.: 13/927,872

(22) Filed: Jun. 26, 2013

(51) Int. Cl. B01J 23/83

(52) U.S. Cl. CPC B01J 23/83
USPC 502/303; 502/304

(57) ABSTRACT

Present disclosure provides a novel process for optimization of Zero-PGM catalyst systems using metallic substrate. Deposition of a homogeneous and well-adhered layer of catalyst on the metallic substrate may be enabled by the selection of a washcoat loading resulting from variation of metal loadings. Characterization of catalysts may be performed using a plurality of catalytic tests, including but not limited to washcoating adherence test, back pressure test, inspection of textural characteristics, and catalyst activity. Optimization may be applied to a plurality of metallic substrates of different geometries and cell densities.

### CROSS-REFERENCE TO RELATED APPLICATIONS

N/A

### BACKGROUND

1. Technical Field

The present disclosure relates generally to Zero-PGM catalyst systems, and, more particularly, to optimization of ZPGM catalyst formulation on metallic substrates.

2. Background Information

Although the most popular substrates may be made from ceramic structures such as cordierite and obtained by extrusion, these substrates have limitations that associated to the flow model may originate a non-homogeneous radial thermal profile. Ceramic substrates may dominate the car market, primarily because they are mass-produced and therefore less costly. However, metallic substrates may offer the industry of catalyst systems significant advantages.

The substrate of a catalytic system fulfills an important role in supporting the catalytic material and may be capable of withstanding some extremely arduous conditions. Operating temperatures may be in excess of 1000° C. and the substrate may also be exposed to fast moving, corrosive exhaust gases, rapid changes in temperature and pressure, and external factors such as shocks and vibration.

An additional important attribute that may be desirable in the metallic substrate, apart from durability, is that it may not cause an excessive pressure drop in the exhaust system. A typical wall thickness of a metallic substrate of about 0.05 mm, when compared with a typical wall thickness of 0.16 mm in a ceramic substrate, may reduce the pressure drop in the exhaust system. Metallic substrates may have a lower specific heat capacity than ceramic materials, which allows catalyst systems on metallic substrates to reach the required operating temperature more quickly after a cold start (quicker light off). Metallic substrates may be less brittle than ceramic substrates, which in turn may allow their installation in places where a catalyst systems based on ceramic substrates may not be installed without risk of suffering damage as a result of shocks and vibration in both diesel and gasoline engines. Additionally, a metallic substrate may be welded into the exhaust system while a ceramic substrate may be retained in a metal casing using expandable fiber materials that may introduce a potential durability problem not foreseen in a metallic substrate.

Nowadays, with more rigorous regulations forcing catalyst manufacturers to devise new technologies to ensure a high catalytic activity, a major problem in the manufacturing of catalyst systems may be achieving the required adhesion of a washcoat and/or overcoat to a metallic substrate. Coating on metallic substrates may be affected by type of materials used and other factors, which include, but are not limited to, substrate geometry and size, substrate cell density, washcoat (WC) and overcoat (OC) particle size and distribution, additive properties, amounts of WC and OC loadings, ratio of alumina to oxygen storage material (OSM), and treatment condition.

For the foregoing, although metallic substrates may be the appropriate choice for motorcycle catalysts and other catalyst system applications as shown by the advantages offered by metallic substrates, there may be a need for improvements in the usage of metallic substrates in Zero-PGM catalyst systems with lower loss of adhesion and improved catalyst performance.

### SUMMARY

The present disclosure may provide a process for overcoming the problem of low adherence of the washcoating when metallic substrates may be used in ZPGM catalysts systems. Optimal coating uniformity of metallic substrates, improved behavior of catalyst under back pressure (BP) conditions, lower % of washcoat adhesion (WCA) loss, and improved catalyst performance may be achieved for ZPGM catalyst systems.

According to embodiments in present disclosure, compositions of ZPGM catalyst systems may include any suitable combination of a metallic substrate, a washcoat, and an overcoat which includes copper (Cu), cerium (Ce), and other metal combinations. Fresh and aged catalyst samples of specific substrate geometry and cells per square inch (CPSI) may be prepared using any suitable synthesis method as known in current art. Fresh and aged catalysts samples may be prepared according to variations of processing parameters of WC loadings to examine the effect on the catalyst samples under back pressure, coating uniformity, WCA loss, and catalyst activity. The process may provide an enhanced preparation to obtain a homogeneous substrate structure and a well adhered washcoating and/or overcoating.

Fresh and aged catalyst samples prepared may have a fixed overcoat loading, and other fixed processing parameters such as pH, and WC and OC particle size. The catalyst samples may be subsequently characterized examining catalyst sample behavior under BP conditions, inspection for coating uniformity of cross section surface area of the catalyst samples, % of WCA loss, and catalyst activity under lean condition, with comparison of HC and CO conversion which may result from variations of WC loadings used in present disclosure.

WC loading resulting in better surface area, better uniformity of coating, lower light-off and optimized WCA loss may be used in processing other metallic substrates geometries, sizes and cell densities. The process of optimizing a ZPGM catalyst on metallic substrate may produce the optimal reduction in WCA loss and enhanced catalyst activity and performance of ZPGM catalyst systems.

Numerous objects and advantages of the present disclosure may be apparent from the detailed description that follows and the drawings which illustrate the embodiments of the present disclosure, and which are incorporated herein by reference.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 shows a verification of WC loading and reproducibility for a D40 mm×L40 mm, 100 cells per square inch (CPSI) metallic substrate, according to an embodiment.

FIG. 2 illustrates verification of BP for fresh catalyst samples on D40 mm×L40 mm, 100 CPSI metallic substrate, according to an embodiment.

FIG. 3 presents verification of coating uniformity for D40 mm×L40 mm, 100 CPSI metallic substrate with WC loading of 60 g/L and OC loading of 120 g/L, according to an embodiment.

FIG. 4 depicts verification of coating uniformity for D40 mm×L40 mm, 100 CPSI metallic substrate with WC loading of 120 g/L and OC loading of 120 g/L, according to an embodiment.

FIG. 5 depicts visual inspection of cross section of catalyst samples on a D40 mm×L40 mm, 100 CPSI metallic substrate, WC loadings of 80 g/L and 120 g/L, according to an embodiment.

FIG. 6 presents verification of % WCA loss for fresh catalyst samples on a D40 mm×L40 mm, 100 CPSI metallic substrate, according to an embodiment.

FIG. 7 shows catalyst activity profiles in HC and CO conversion for fresh catalyst samples on a D40 mm×L40 mm, 100 CPSI metallic substrate, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### Definitions

As used here, the following terms have the following definitions:

“Substrate” may refer to any material of any shape or configuration that yields a sufficient surface area for depositing a washcoat and/or overcoat.

“Washcoat” may refer to at least one coating including at least one oxide solid that may be deposited on a substrate.

“Overcoat” may refer to at least one coating that may be deposited on at least one washcoat layer.

“Catalyst” may refer to one or more materials that may be of use in the conversion of one or more other materials.

“Zero platinum group (ZPGM) catalyst” may refer to a catalyst completely or substantially free of platinum group metals.

“Co-precipitation” may refer to the carrying down by a precipitate of substances normally soluble under the conditions employed.

“Milling” may refer to the operation of breaking a solid material into a desired grain or particle size.

“Carrier material oxide (CMO)” may refer to support materials used for providing a surface for at least one catalyst.

“Oxygen storage material (OSM)” may refer to a material able to take up oxygen from oxygen rich streams and able to release oxygen to oxygen deficient streams.

“Treating,” “treated,” or “treatment” may refer to drying, firing, heating, evaporating, calcining, or combinations thereof.

“Calcination” may refer to a thermal treatment process applied to solid materials, in presence of air, to bring about a thermal decomposition, phase transition, or removal of a volatile fraction at temperatures below the melting point of the solid materials.

“Conversion” may refer to the chemical alteration of at least one material into one or more other materials.

“T50” may refer to the temperature at which 50% of a material is converted.

### DESCRIPTION OF THE DRAWINGS

Various example embodiments of the present disclosure are described more fully with reference to the accompanying drawings in which some example embodiments of the present disclosure are shown. Illustrative embodiments of the present disclosure are disclosed here. However, specific structural and functional details disclosed here are merely representative for purposes of describing example embodiments of the present disclosure. This disclosure however, may be embodied in many alternate forms and should not be construed as limited to only the embodiments set forth in the present disclosure.

ZPGM Catalyst System Configuration and Composition

According to embodiments in the present disclosure, a ZPGM catalyst system may include at least a metallic substrate, a washcoat (WC), and an overcoat (OC). WC and OC may include at least one ZPGM catalyst. WC may be formed on a metallic substrate by suspending the oxide solids in water to form an aqueous slurry and depositing the aqueous slurry on substrate as washcoat. Subsequently, in order to form ZPGM catalyst system, OC may be deposited on WC.

Metallic Substrates

Metallic substrates may be in the form of beads or pellets or of any suitable form. The beads or pellets may be formed from any suitable material such as alumina, silica alumina, silica, titania, mixtures thereof, or any suitable material. If substrate is a metal honeycomb, the metal may be a heat-resistant base metal alloy, particularly an alloy in which iron is a substantial or major component. The surface of the metal substrate may be oxidized at temperatures higher than 1000° C. to improve the corrosion resistance of the alloy by forming an oxide layer on the surface of the alloy.

Metallic substrate may be a monolithic carrier having a plurality of fine, parallel flow passages extending through the monolith. The passages may be of any suitable cross-sectional shape and/or size. The passages may be trapezoidal, rectangular, square, sinusoidal, hexagonal, oval, or circular, although other shapes may be suitable. The monolith may contain from about 9 to about 1,200 or more gas inlet openings or passages per square inch of cross section, although fewer passages may be used. Metallic substrate may be used with different dimension and cell density (CPSI).

WC Material Composition and Preparation

According to embodiments in the present disclosure, a WC may free of ZPGM transition metal catalyst. A WC may include support oxides material referred to as carrier material oxides (CMO) which may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. According to embodiments in present disclosure, the support oxide may preferably include any type of alumina or doped alumina. WC may include oxygen storage materials (OSM), such as cerium, zirconium, lanthanum, yttrium, lanthanides, actinides, and mixtures thereof. The OSM and the alumina may be present in WC in a ratio between 40% to about 60% by weight.

In some embodiments, WC may also include other components such as acid or base solutions or various salts or organic compounds that may be added to adjust rheology of the WC slurry. These compounds may be added to enhance the adhesion of washcoat to the metallic substrate. Compounds that may be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol, amongst others.

Preparation of WC may be achieved at room temperature. WC may be prepared by milling powder forms including WC materials in any suitable mill such as vertical or horizontal mills. WC materials may be initially mixed with water or any suitable organic solvent. Suitable organic solvents may include ethanol, and diethyl ether, carbon tetrachloride, and trichloroethylene, amongst others. Powder WC materials may include ZPGM transition metal catalyst and CMOs, as previously described. Subsequently, mixed WC materials may be milled down into smaller particle sizes during a period of time from about 10 minutes to about 10 hours, depending on the batch size, kind of material and particle size desired. According to embodiments in the present disclosure WC particle size of the WC slurry may be of about 4 μmto about 10 μm in order to get uniform distribution of WC particles.

The milled WC, in the form of aqueous slurry may be deposited on a metallic substrate employing vacuum dosing and coating systems and may be subsequently treated. A plurality of deposition methods may be employed, such as placing, adhering, curing, coating, spraying, dipping, painting, or any known process for coating a film on at least one metallic substrate. If the metallic substrate is a monolithic carrier with parallel flow passages, WC may be formed on the walls of the passages. Various capacities of WC loadings in the present disclosure may be coated on the metallic substrate. The WC loading may vary from 60 g/L to 200 g/L.

After depositing WC on the metallic substrate, according to embodiments in the present disclosure WC may be treated by drying and heating. For drying the WC, air knife drying systems may be employed. Heat treatments may be performed using commercially-available firing (calcination) systems. The treatment may take from about 2 hours to about 6 hours, preferably about 4 hours, and at a temperature of about 300° C. to about 700° C., preferably about 550° C. After WC is treated and cooled at room temperature, OC may be deposited on WC.

OC Material Composition and Preparation

The overcoat may include ZPGM transition metal catalysts, including at least one or more transition metals, and at least one rare earth metal, or mixture thereof that are completely free of platinum group metals. The transition metals may be a single transition metal, or a mixture of transition metals which may include chromium, manganese, iron, cobalt, nickel, niobium, molybdenum, tungsten, and Cu. In the present disclosure, preferably, the ZPGM transition metal may be Cu. Preferred rare earth metal may be cerium (Ce). The total amount of Cu catalyst included in OC may be of about 5% by weight to about 50% by weight of the total catalyst weight, preferably of about 10% to 16% by weight. Furthermore, the total amount of Ce catalyst included in OC may be of about 5% by weight to about 50% by weight of the total catalyst weight, preferably of about 12% to 20% by weight. Different Cu and Ce salts such as nitrate, acetate or chloride may be used as ZPGM catalysts precursors.

OC may include CMOs. CMOs may include aluminum oxide, doped aluminum oxide, spinel, delafossite, lyonsite, garnet, perovksite, pyroclore, doped ceria, fluorite, zirconium oxide, doped zirconia, titanium oxide, tin oxide, silicon dioxide, zeolite, and mixtures thereof. According to embodiments in present disclosure, CMO in the OC may be any type of alumina or doped alumina. The doped aluminum oxide in OC may include one or more selected from the group consisting of lanthanum, yttrium, lanthanides and mixtures thereof. CMO may be present in OC in a ratio between 40% to about 60% by weight.

Additionally, according to embodiments in the present disclosure, OC may also include OSM. Amount of OSM may be of about 10% to about 90% by weight, preferably of about 40% to about 75% by weight. The weight of OSM is on the basis of the oxides. The OSM may include at least one oxide selected from the group consisting of zirconium, lanthanum, yttrium, lanthanides, actinides, Ce, and mixtures thereof. OSM in the present OC may be a mixture of ceria and zirconia; more suitable, a mixture of (1) ceria, zirconia, and lanthanum or (2) ceria, zirconia, neodymium, and praseodymium, and most suitable, a mixture of cerium, zirconium, and neodymium. OSM may be present in OC in a ratio between 40% to about 60% by weight. Cu and Ce in OC are present in about 5% to about 50% by weight or from about 10% to 16% by weight of Cu and 12% to 20% by weight of Ce.

The OC may be prepared by co-precipitation synthesis method. Preparation may begin by mixing the appropriate amount of Cu and Ce salts, such as nitrate, acetate or chloride solutions, where the suitable Cu loadings may include loadings in a range as previously described. Subsequently, the Cu—Ce solution is mixed with the slurry of CMO support. Co-precipitation of the OC may include the addition of appropriate amount of one or more of NaOH solution, Na₂CO₃ solution, and ammonium hydroxide (NH₄OH) solution. The pH of OC slurry may be adjusted to a desired value by adjusting the rheology of the aqueous OC slurry adding acid or base solutions or various salts or organic compounds, such as, ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol, and other suitable compounds. The OC slurry may be aged for a period of time of about 12 to 24 hours under continues stirring. This precipitation may be formed over a slurry including at least one suitable CMO, or any number of additional suitable CMOs, and may include one or more suitable OSMs as previously described. After precipitation, the OC slurry may undergo filtering and washing, and then OC may be deposited on WC by employing suitable deposition techniques such as vacuum dosing, amongst others. The OC loading may vary from 60 g/L to 200 g/L. OC may then be dried and treated employing suitable heat treatment techniques employing firing (calcination) systems or any other suitable treatment techniques. The ramp of heating treatment may vary. In an embodiment, treating of washcoat may not be required prior to application of overcoat. In this case, OC, WC, and metallic substrate may be treated for about 2 hours to about 6 hours, preferably about 4 hours, at a temperature of about 300° C. to about 700° C., preferably about 550° C.

Control Parameters for Optimization of ZPGM Catalyst System on Metallic Substrates

According to embodiments in the present disclosure, WC loadings, back pressure, and WCA may be controlled to have better uniformity of coating, reduction of WCA loss, and higher catalyst activity. Varying washcoat loadings may have an influence in coating uniformity, WCA, and performance of ZPGM catalyst systems on metallic substrates.

The control parameters that may be used in the present disclosure may include a plurality of washcoat loadings to prepare ZPGM catalyst samples on a metallic substrate with a specific geometry and concentration. The fresh and aged catalyst samples may be characterized and tested for verification of behavior under back pressure conditions, coating uniformity, desired level of WCA loss, and catalyst activity. The optimal results from variations of washcoat loadings may be registered and applied to a plurality of metallic substrates for verification of catalyst performance.

The following example is intended to illustrate the scope of the disclosure. It is to be understood that other procedures known to those skilled in the art may alternatively be used.

### Example #—Preparation of a ZPGM Catalyst System on Metallic Substrate

Example #1 may illustrate the optimization processing for ZPGM catalyst on a D40 mm×L40 mm, 100 CPSI metallic substrate. Processing parameters may be used to prepare catalyst samples and to control coating uniformity, behavior under back pressure, % WCA loss, and catalyst activity. Accordingly, catalyst samples may be prepared to include WC loadings of 60 g/L, 80 g/L, 100 g/L, and 120 g/L. WC may include alumina as support oxide. WC is free of OSM and ZPGM material. The WC is prepared by milling process and the particle size of washcoat adjusted to about 6.5 μm by controlling the time of milling. The OC is prepared by co-precipitation method at pH=5.5-6.5 and may have a total loading of 120 g/L, including doped alumina as CMO, and OSM. Overcoat include Cu with a loading of 10 g/L to 15 g/L and Ce with loading of 12 g/L to 18 g/L. Samples may be aged at 900° C. for 4 hours under dry condition.

After fresh and aged catalyst samples may be prepared using the variations of WC loading, all samples may be subjected to characterization and testing for verification of washcoat loading and reproducibility; verification of behavior under back pressure for both sides of the catalyst samples; inspection coating uniformity in the cross sections of substrate; verification of washcoat adherence in terms of % WCA loss; and catalyst activity under exhaust lean condition. Analysis of catalyst activity of samples may employ the resulting HC T50 to compare the activity in HC conversion of the catalyst samples.

Verification of Washcoat Loading and Reproducibility

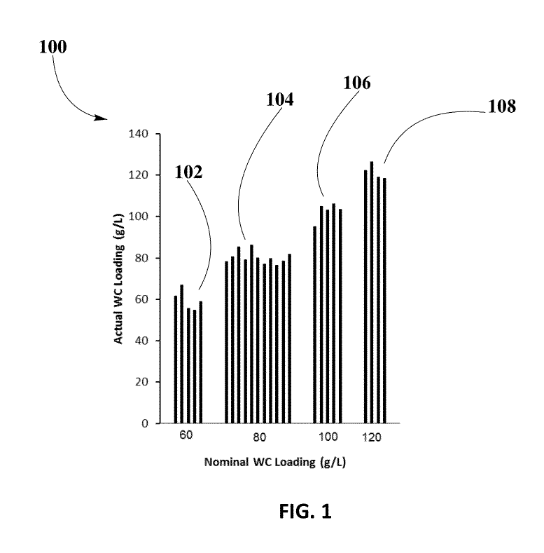

FIG. 1 shows verification of WC loading and reproducibility 100 for a D40 mm×L40 mm, 100 CPSI metallic substrate, of example #1. Bar chart 102 shows reproducibility of coating loading for nominal WC loading of 60 g/L; bar chart 104, shows reproducibility of coating loading for nominal WC loading of 80 g/L; bar chart 106 shows reproducibility of coating loading for nominal WC loading of 100 g/L; and bar chart 108 shows reproducibility of coating loading for WC loading of 120 g/L. OC loading for all samples may be targeted at 120 g/L and during monitoring OC loading may be obtained within ±5% of target.

As may be seen in bar chart 102, from a total of 5 samples, the reproducibility that may be obtained is within a range from about −8.5% to about 11.4% within target of 60 g/L. In bar chart 104 may be seen that from a total of 11 samples reproducibility is within a range from about −4.6% to about 7.8% within target of 80 g/L. In bar chart 106 may be seen that from a total of 5 samples reproducibility is within a range from about −4.8% to about 6.0% within target of 100 g/L. In bar chart 108 may be seen that from 4 samples reproducibility is within a range from −1.7% to about 5.5% within target of 120 g/L.

The verification of washcoat loading and reproducibility indicate that samples with WC loading of 60 g/L may not provide a good reproducibility for optimization of metallic substrates. Samples for WC loading of 80 g/L and 100 g/L may provide improved reproducibility, but samples with WC loading of 120 g/L, having the lowest variation within target, may provide a better reproducibility of coating loading.

Verification of Back Pressure

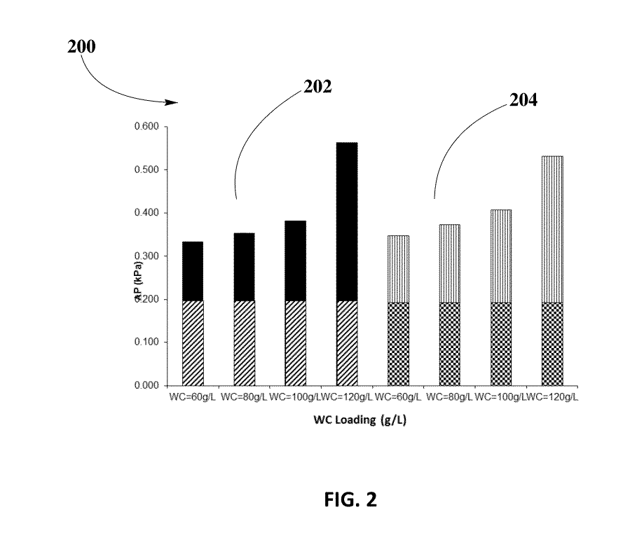

FIG. 2 illustrates verification of BP 200 for fresh catalyst samples on D40 mm×L40 mm, 100 CPSI metallic substrate, of example #1. For comparison of variations of back pressure, testing may be performed on a blank metallic substrate and a coated substrate varying WC loadings of 60 g/L, 80 g/L, 100 g/L, and 120 g/L. Back pressure testing may be performed on both sides of the substrate flowing an air flow of 1.0 m³/min, at 25° C.

As may be seen in verification of BP 200, bar chart 202 shows results of testing fresh samples on one side of blank metallic substrates (slanted line bars) with inlet to outlet direction and on the same side using coated metallic substrates (solid black bars). Bar chart 204 shows results of testing fresh samples on the opposite side of blank metallic substrates of bar chart 202 (mesh pattern bars) with outlet to inlet direction and on the same opposite side using coated metallic substrates (vertical line bars). As may be seen in bar chart 202 and 204, for both sides with blank metallic substrate or coated metallic substrate, BP is approximately constant, only showing a greater BP for WC loading of 120 g/L.

When testing is performed inlet-outlet side of blank metallic substrates, BP slightly changes from about 0.198 kPa to about 0.194 kPa for the opposite side (outlet-inlet) of the blank metallic substrates showing no clogged cells in the blank substrate. When results from testing coated metallic substrates may be compared from one side to the other, it may be seen that for WC loading of 60 g/L, BP changes from about 0.333 kPa to about 0.348 kPa; for WC loading of 80 g/L, BP changes from 0.352 kPa to 0.374 kPa; for WC loading of 100 g/L, and BP changes from 0.381 kPa to 0.408 kPa, which shows uniformity of coating on substrate's cells. However, for WC loading of 120 g/L, BP changes from 0.562 kPa to 0.533 kPa. This level of BP may be due to presence of thick coating and catalyst samples with WC loading of 60 g/L, 80 g/L, and 100 g/L may be within the acceptable range for optimized catalyst activity.

Verification of Coating Uniformity

Coating uniformity of prepared catalyst samples of example #1 may be verified by visual inspection of cross section of each coated substrate. After resin molding, the catalyst samples are cut and subsequently sanded.

Visual inspections of the thickness and coating uniformity in the WC and OC of the metallic substrate may be performed for WC loadings of 60 g/L, 80 g/L, 100 g/L, and 120 g/L. Visual inspections may be performed and pictures of the sections taken at the inlet and outlet sections of substrate and at the center of the cross sections. From these inspections a reference washcoat loading may be obtained for optimization of metallic substrates according to principles in the present disclosure.

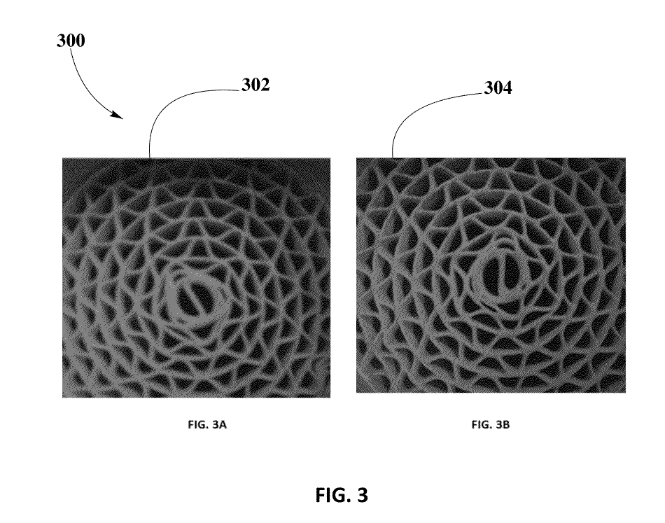

FIG. 3 presents verification of coating uniformity 300 for D40 mm×L40 mm, 100 CPSI metallic substrate of example #1. FIG. 3A depicts coating uniformity 302 at the inlet of catalyst sample with WC loading of 60 g/L and OC loading of 120 g/L. FIG. 3B depicts coating uniformity 304 at the outlet of catalyst sample with WC loading of 60 g/L and OC loading of 120 g/L.

From coating uniformity 302 and 304 may be observed that there is coating uniformity at the outlet and inlet of a catalyst sample prepared with WC loading of 60 g/L and OC loading of 120 g/L. The same textural characteristics of uniform coating may be observed for WC loadings of 80 g/L and 100 g/L, with an OC loading of 120 g/L.

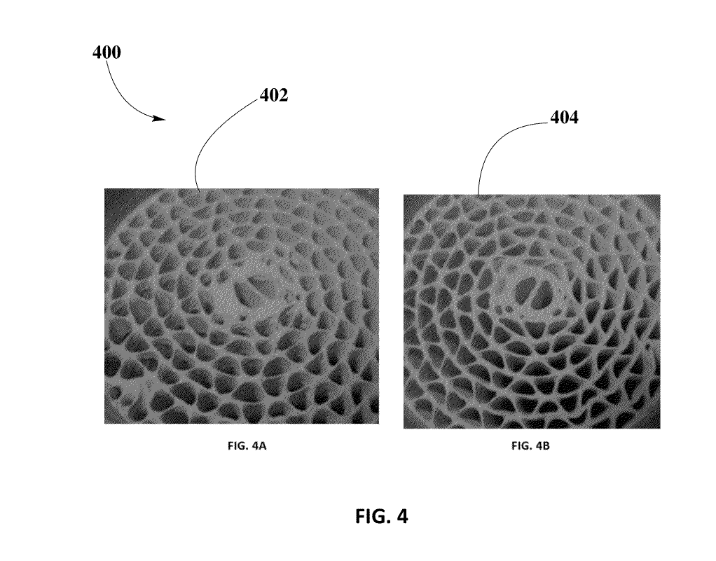

FIG. 4 depicts verification of coating uniformity 400 for D40 mm×L40 mm, 100 CPSI metallic substrate with WC loading of 120 g/L of example #1. FIG. 4A depicts inlet coating uniformity 402 at the inlet of catalyst sample with WC loading of 120 g/L and OC loading of 120 g/L. FIG. 4B depicts coating uniformity 404 at the outlet of catalyst sample with WC loading of 120 g/L and OC loading of 120 g/L.

From coating uniformity 402 and 404 may be observed that there is no coating uniformity at the outlet and inlet of a catalyst sample prepared with WC loading of 120 g/L and OC loading of 120 g/L.

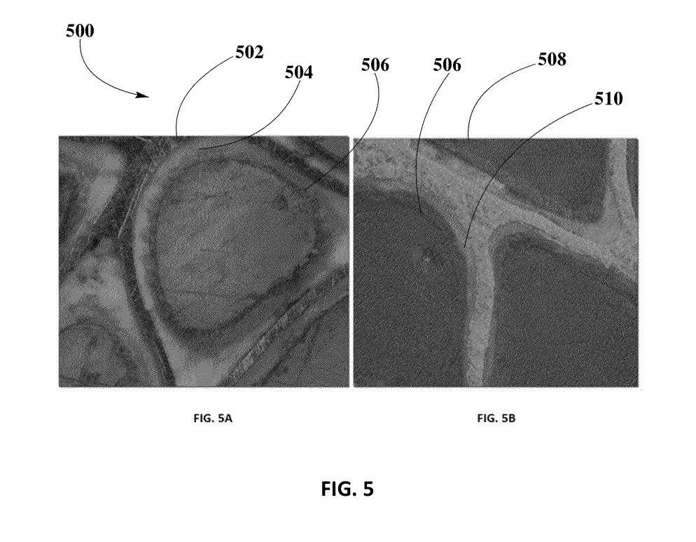

FIG. 5 illustrates visual inspection 500 of cross section of catalyst samples on a D40 mm×L40 mm, 100 CPSI metallic substrate, WC loadings 80 g/L and 120 g/L, with OC loading of 120 g/L in example#1. Visual inspection 500 is a magnification of loading thickness for catalyst samples of different WC loading. FIG. 5A depicts coating uniformity 502 at the cross section of catalyst samples with WC loading of 120 g/L and OC loading of 120 g/L. Magnification of WC loading thickness 504 and OC loading thickness 506 may assist in the verification of coating uniformity in the samples. FIG. 5B depicts coating uniformity 508 at the cross section of catalyst samples with WC loading of 80 g/L and OC loading of 120 g/L. Magnification of WC loading thickness 510 and OC loading thickness 506 may may assist in the verification of coating uniformity in the samples.

From visual inspection 500 may be seen that a comparison of samples with WC loadings of 80 g/L and 120 g/L may indicate that there is more penetration of OC particles through the WC layer when the WC loading may be thicker (120 g/L). However, there is solid boundary between WC and OC when the WC loading is thinner (80 g/L). The penetration of OC particles to WC layer may affect WCA and catalyst performance.

Verification of Washcoat Adhesion

WCA may be verified for samples prepared according to formulation of catalyst samples in example #1. Verification may be performed using a washcoating adherence test as known in the art. The washcoat adhesion test is performed by quenching the preheated substrate at 550° C. to cold water with angle of 45 degree for 8 seconds followed by re-heating to 150° C. and then blowing cold air at 2,800 L/min. Subsequently, weight loss may be measured to calculate weight loss percentage, which is % WCA loss in present disclosure.

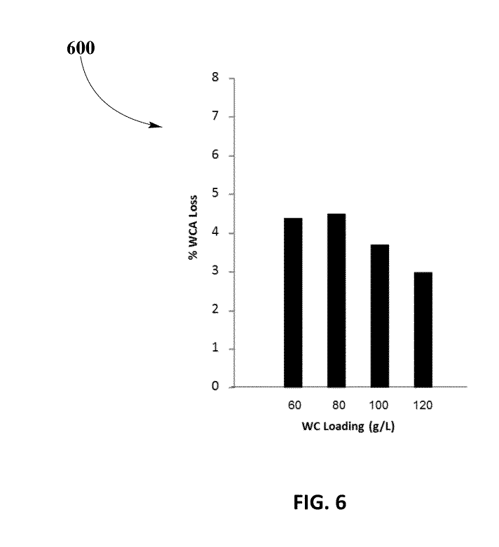

FIG. 6 presents verification of % WCA loss 600 for fresh catalyst samples on a D40 mm×L40 mm, 100 CPSI metallic substrate, according to an embodiment. As may be seen, fresh samples with WC loading of 60 g/L show % WCA loss of about 4.3%; fresh samples with WC loading of 80 g/L show % WCA loss of about 4.5%; fresh samples with WC loading of 100 g/L show % WCA loss of about 3.8%; and fresh samples with WC loading of 120 g/L show % WCA loss of about 3%, which is the lowest percentage of WCA loss that result from the analysis of fresh samples with different WC loading according to principles in the present disclosure.

A thicker layer of WC which may be provided by higher WC loadings, results is better adhesion between OC particles and WC particles because the OC particles may penetrate through WC layer. This may also be seen from the verification of coating uniformity in visual inspection 500, where the magnification of resulting WC loading thickness 504, 510 and OC loading thickness 506 show that the OC layer penetrates inside the WC layer in case of WC loading of 120 g/L, but in case of WC loading of 80 g/L there is a solid boundary between the WC and OC layers (FIG. 5). The higher penetration or connection between the OC and WC layers, the lower WCA loss, but may not results in better activity. Additionally, WCA may strongly depend on the substrate cell density and it may be expected that WCA loss may be less for metallic substrates of greater cell density than the cell density of 100 CPSI used for the catalyst samples in the present disclosure.

Verification of Catalyst Activity

Verification of catalyst activity of both fresh catalyst samples in example #1 may be performed under lean exhaust condition using a total flow of 20.1 L/min with toluene as feed hydrocarbon.

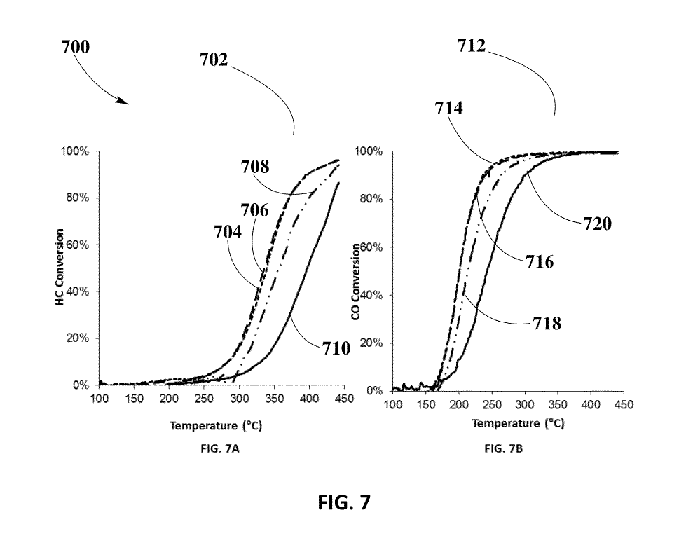

FIG. 7 shows catalyst activity profile 700 in HC and CO conversion for fresh catalyst samples on a D40 mm×L40 mm, 100 CPSI metallic substrate, prepared with the formulation described in example #1, according to an embodiment.

FIG. 7A shows HC conversion graph 702 for WC loadings in the present disclosure. HC conversion 704 is for WC loading of 60 g/L (dot line); HC conversion 706 is for WC loading of 80 g/L (dash line); HC conversion 708 is for WC loading of 100 g/L (double dot dash line); and HC conversion 710 is for WC loading of 120 g/L (solid line).

FIG. 7B shows CO conversion graph 712 for WC loadings in the present disclosure. CO conversion 714 is for WC loading of 60 g/L (dot line), CO conversion 716 is for WC loading of 80 g/L (dash line). CO conversion 718 is for WC loading of 100 g/L (double dot dash line) and CO conversion 720 is for WC loading of 120 g/L (solid line).

The temperatures HC T50 registered are 339° C. for WC loading of 60 g/L, 336° C. for WC loading of 80 g/L, 357° C. for WC loading of 100 g/L, and 397° C. for WC loading of 120 g/L. This indicates that decreasing WC loading leads to decreased T50 for HC and CO conversion. Additionally, in monitoring catalyst activity of samples for HC and CO conversion no difference may be observed for WC loadings of 60 g/L and 80 g/L. when the WC is thinner (lower loading) with the same thickness of OC, more surface area is available for gas component to contact catalyst. Therefore, the lower loading of WC results in better activity.

As may be seen in this process for optimization of metallic substrates in ZPGM catalyst systems, when catalyst activity is verified, in spite of the resulting lowest percentage of WCA loss of about 3%, as obtained from the analysis of fresh samples with WC loading of 120 g/L, lowest activity is observed for samples with WC loading of 120 g/L, as indicated by a temperature HC T50 of 397° C. These results may not provide the desired optimization of WCA and improved catalyst activity. The highest catalyst activity may be achieved with WC loadings of 60 g/L and 80 g/L. Additionally, catalyst samples with WC loadings of 60 g/L and 80 g/L, show same level of WCA loss between 4.3% and 4.5%, respectively. However, for WC loading of 80 g/L, BP changes within the range of about 0.352 kPa to about 0.374 kPa indicates better uniformity of coating on substrate's cells. The optimal point for all loading verification, BP, uniformity of coating, WCA loss, and catalyst activity may be a WC loading of 80 g/L.

A WC loading of 80 g/L may be registered as a loading threshold for optimization of metallic substrates in ZPGM catalyst systems.

From the verification of washcoat loadings, behavior under back pressure, coating uniformity, WCA loss, and catalyst activity for catalyst samples in the present disclosure may be observed that with lower WC thickness, a better catalyst activity may be achieved. Additionally, coatability may be improved in catalyst samples prepared with lower WC loading because better uniformity of coating may be achieved.

What is claimed is:

1. A method for improving performance of catalytic systems, comprising:
providing at least one substrate;
depositing a washcoat suitable for deposition on the substrate, the washcoat comprising at least one oxide solid further comprising at least one carrier metal oxide;
depositing an overcoat suitable for deposition on the substrate, the overcoat comprising at least one ZPGM catalyst;
wherein the washcoat is deposited at about 60 g/L to about 100 g/L; and
wherein the substrate exhibits a back pressure of about 0.300 kPa to about 0.400 kPa when receiving an air flow of about 1.0 m³/min.

2. The method according to claim 1, wherein the washcoat is heated for about 2 to about 6 hours.

3. The method according to claim 1, wherein the washcoat is heated for about 4 hours.

4. The method according to claim 1, wherein the washcoat is heated between about 300° C. and about 700° C.

5. The method according to claim 1, wherein the washcoat is heated about 550° C.

6. The method according to claim 1, wherein the substrate is about 100 cells per square inch.

7. The method according to claim 1, wherein the substrate comprises metal.

8. The method according to claim 1, wherein the at least one carrier material oxide comprises one selected from the group consisting of aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof.

9. The method according to claim 1, wherein the washcoat further comprises at least one oxygen storage material.

10. The method according to claim 9, wherein the at least one oxygen storage material is selected from the group consisting of cerium, zirconium, lanthanum, yttrium, lanthanides, actinides, and mixtures thereof.

11. The method according to claim 9, wherein the ratio of the at least one oxygen storage material to the at least one carrier metal oxide is 2:3.

12. The method according to claim 1, wherein loss of the deposited washcoat is less than about 5%.

13. The method according to claim 1, wherein the T50 for hydrocarbon conversion is about 339° C.

14. The method according to claim 1, wherein the T50 for hydrocarbon conversion is about 336° C.

15. The method according to claim 1, wherein the T50 for hydrocarbon conversion is about 357° C.

16. The method according to claim 1, wherein the T50 for carbon monoxide conversion is about 200° C.

17. The method according to claim 1, wherein the T50 for carbon monoxide conversion is about 250° C.

18. The method according to claim 1, wherein the exhibited back pressure is indicative of uniform washcoat deposition.

19. The method according to claim 1, wherein the at least one ZPGM catalyst comprises one selected from the group consisting of copper, cerium, and combinations thereof.
